(19) United States
(12) Patent Application Publication
(10) Pub. No.: US 2024/0394904 A1
(43) Pub. Date: Nov. 28, 2024

(54) EXTRACTION DEVICE, IMAGE ANALYSIS DEVICE, CREATING DEVICE, EVALUATION SYSTEM, CORRELATION DISTANCE EXTRACTION METHOD, AND RECORDING MEDIUM

(71) Applicant: NEC Corporation, Tokyo (JP)

(72) Inventors: Taizo SHIBUYA, Tokyo (JP); Tomo Tanaka, Tokyo (JP); Noriyuki Tonouchi, Tokyo (JP)

(73) Assignee: NEC Corporation, Tokyo (JP)

(21) Appl. No.: 18/661,860

(22) Filed: May 13, 2024

(30) Foreign Application Priority Data
May 26, 2023 (JP) 2023-087224

(51) Int. Cl. G06T 7/60

(52) U.S. Cl. CPC G06T 7/60; G06T 2207/10056

(57) ABSTRACT

An extraction device includes a memory configured to store instructions; and a processor configured to execute the instructions to extract a plurality of nanorods based on an image of a network structure including a plurality of constituent elements approximated to the plurality of nanorods, acquire an inter-nanorod distance and an angle between each pair of the plurality of nanorods, and determine a correlation distance based on a relationship between the inter-nanorod distance and the angle.

Priority is claimed on Japanese Patent Application No. 2023-087224, filed May 26, 2023, the content of which is incorporated herein by reference.

### TECHNICAL FIELD

The present disclosure relates to an extraction device, an image analysis device, a creating device, an evaluation system, a correlation distance extraction method, and a recording medium.

### BACKGROUND ART

It is known that carbon nanotubes are used in various elements.

For example, Japanese Unexamined Patent Application, First Publication No. 2010-52972 (hereinafter Patent Document 1) discloses carbon nanotubes that are randomly entangled to form a network.

### SUMMARY

In the disclosure of Patent Document 1, a graphite film is formed on the surfaces of carbon nanotubes by treating a carbon nanotube network with Ga vapor. The electrical resistance of the graphite film is lowered by connecting the carbon nanotubes to each other via this graphite film. However, even when the graphite film is formed on the surfaces of carbon nanotubes, it may be difficult to lower the electrical resistance of a network structure depending on the orientation of the carbon nanotubes.

An example object of the disclosure is to provide an extraction device, an image analysis device, a creating device, an evaluation system, a correlation distance extraction method, and a recording medium for solving the above-mentioned problems.

An extraction device according to an example aspect of the disclosure includes a memory configured to store instructions; and a processor configured to execute the instructions to extract a plurality of nanorods based on an image of a network structure including a plurality of constituent elements approximated to the plurality of nanorods, acquire an inter-nanorod distance and an angle between each pair of the plurality of nanorods, and determine a correlation distance based on a relationship between the inter-nanorod distance and the angle.

A creating device according to an example aspect of the disclosure includes a memory configured to store instructions; and a processor configured to execute the instructions to: determine a plurality of centers, set a correlation distance for each center, and set a plurality of nanorods based on the correlation distance and a center-to-center distance which is a distance between each pair of the plurality of centers.

An evaluation system according to an example aspect of the disclosure includes a microscope, an extraction device, and a creating device, in which the microscope is configured to capture an image of a network structure including a plurality of constituent elements approximated to a plurality of nanorods, in which the extraction device includes: a first memory configured to store first instructions; and a first processor configured to execute the first instructions to: extract the plurality of nanorods based on the image, acquire an inter-nanorod distance and an angle between each pair of the plurality of nanorods, and determine a correlation distance based on a relationship between the inter-nanorod distance and the angle, and in which the creating device includes: a second memory configured to store second instructions; and a second processor configured to execute the second instructions to: determine a plurality of centers, set a correlation distance for each center, and set a plurality of nanorods based on the correlation distance and a center-to-center distance which is a distance between each pair of the plurality of centers.

A correlation distance extraction method according to an example aspect of the disclosure includes extracting a plurality of nanorods based on an image of a network structure including a plurality of constituent elements approximated to the plurality of nanorods, acquiring an inter-nanorod distance and an angle between each pair of the plurality of nanorods, and determining a correlation distance based on a relationship between the inter-nanorod distance and the angle.

A recording medium according to an example aspect of the disclosure is a non-transitory computer-readable recording medium that records a program causing a computer to execute steps including extracting a plurality of nanorods based on an image of a network structure including a plurality of constituent elements approximated to the plurality of nanorods, acquiring an inter-nanorod distance and an angle between each pair of the plurality of nanorods, and determining a correlation distance based on a relationship between the inter-nanorod distance and the angle.

According to the above-described aspect, it is easy to lower the electrical resistance of a network structure.

### BRIEF DESCRIPTION OF THE DRAWINGS

FIG. 1 is a configuration diagram of an evaluation system in some example embodiments of the present disclosure.

FIG. 2 is a block diagram of a creating device in some example embodiments of the present disclosure.

FIG. 3 is a block diagram of an extraction device in some example embodiments of the present disclosure.

FIG. 4 is a flow diagram of a data creation method in some example embodiments of the present disclosure.

FIG. 5 is a diagram showing processing of a distribution unit in the data creation method in some example embodiments of the present disclosure.

FIG. 6 is a diagram I showing processing of a second setting unit in the data creation method in some example embodiments of the present disclosure.

FIG. 7 is a diagram II showing processing of the second setting unit in the data creation method in some example embodiments of the present disclosure.

FIG. 8 is a flow diagram of a correlation distance extraction method in some example embodiments of the present disclosure.

FIG. 9 is a diagram showing processing of a calculation unit in the correlation distance extraction method in some example embodiments of the present disclosure.

FIG. 10 is a plan view I of a network structure in an example.

FIG. 11 is a plan view II of the network structure in the example.

FIG. 12 is a plan view III of the network structure in the example.

FIG. 13 is a diagram showing a relationship between a correlation distance and a resistance value in the network structure in the example.

FIG. 14 is a diagram showing a relationship between a center-to-center distance and an average angle in the network structure the example. FIG. 15 is a diagram showing a creating device in some example embodiments of the present disclosure.

FIG. 16 is a diagram showing an extraction device in some example embodiments of the present disclosure.

FIG. 17 is a diagram showing an evaluation system in some example embodiments of the present disclosure.

FIG. 18 is a flow diagram of a data creation method in some example embodiments of the present disclosure.

FIG. 19 is a flow diagram of a correlation distance extraction method in some example embodiments of the present disclosure.

FIG. 20 is a diagram I showing extraction of a distance between nanorods which is performed by an extraction device in a modification example.

FIG. 21 is a diagram II showing extraction of a distance between nanorods which is performed by the extraction device in the modification example.

FIG. 22 is a diagram III showing extraction of a distance between nanorods which is performed by the extraction device in the modification example.

FIG. 23 is a diagram showing determination of a correlation distance which is performed by the extraction device in the modification example.

### EXAMPLE EMBODIMENT

Hereinafter, example embodiments according to the disclosure will be described with reference to the drawings. The drawings and specific configurations used in the example embodiments should not be used to interpret the disclosure. In all of the drawings, the same or corresponding configurations are denoted by the same reference numerals and signs, and common descriptions are omitted.

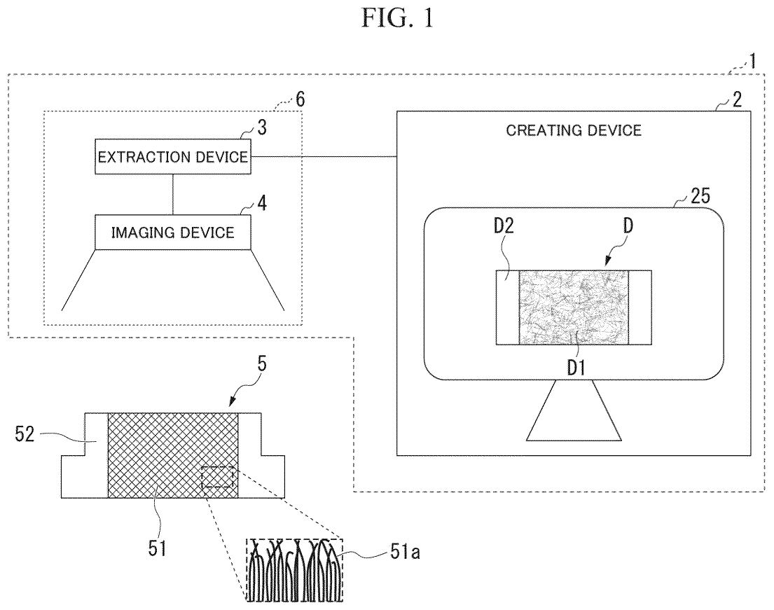

Some example embodiments of the present disclosure will be described below with reference to FIGS. 1 to 9 and FIGS. 13 and 14.

### Configuration of Evaluation System

As shown in FIG. 1, an evaluation system 1 includes a creating device 2 and an image analysis device 6.

The creating device 2 creates information regarding a network structure D1 included in a data element D, which will be described later. The image analysis device 6 includes an extraction device 3 and an imaging device 4.

The extraction device 3 extracts information regarding a network structure 51 included in an element 5.

The imaging device 4 is a device for imaging the element 5. For example, the imaging device 4 includes an atomic force microscope (AFM), a scanning electron microscope (SEM), a transmission electron microscope (TEM), or the like, and may be a device that can capture microscopic images of a plurality of constituent elements 51a included in the network structure 51 of the element 5.

The imaging device 4 transmits a captured image to the extraction device 3.

For example, the element 5 includes the network structure 51 and two electrodes 52.

The network structure 51 includes the plurality of constituent elements 51a. The constituent element 51a is a nanocarbon. The nanocarbon is a nano-sized carbon material whose main constituent element is carbon, such as a single-walled carbon nanotube, a double-walled carbon nanotube, a multi-walled carbon nanotube, a carbon nanorod, a carbon nanohorn, a carbon nanobrush, a carbon nanotwist, graphene, or fullerene.

For example, the constituent element 51a may have a rod shape such as a single-walled carbon nanotube, a double-walled carbon nanotube, a multi-walled carbon nanotube, or a carbon nanorod. The constituent element 51a may have a rod shape in which a plurality of nanocarbons are connected.

Regarding an electrode 52, a pair of electrodes may be formed to embrace the network structure 51.

The evaluation system 1 can display information regarding a network structure D1 of a data element D created by the creating device 2 and information regarding the network structure 51 of the element 5 extracted by the extraction device 3. Thereby, an operator can evaluate each correlation distance R obtained by the creating device 2 and the extraction device 3, each image showing the degree of orientation obtained by the creating device 2 and the extraction device 3, a table related to the network structure D1 of the element D which is created by the creating device 2, and a graph related to the network structure 51 of the element 5 which is created by the extraction device 3, and can perform preliminary examination for reducing the resistance of the network structure 51.

For example, when the creating device 2 calculates a resistance value, the data element D may include two electrodes D2 and the network structure D1. At this time, the two electrodes D2 are electrically connected to each other so as to cover end faces at both right and left ends of the network structure D1.

For example, the extraction device 3 may use an image obtained by capturing the data element D created by the creating device 2 as a captured image. Thereby, the operator can compare a captured image processed by the extraction device 3 with the image obtained by capturing the data element D created by the creating device 2 in the evaluation system 1 and confirm approximation between nanorods. In the present example embodiments, in order to show a relationship between data obtained by the processing of the extraction device 3 and the correlation distance R, an image obtained by capturing the data element D created by the creating device 2 is used as a captured image.

For example, the evaluation system 1 may transmit and receive data between the creating device 2 and the extraction device 3.

### Functional Configuration of Creating Device

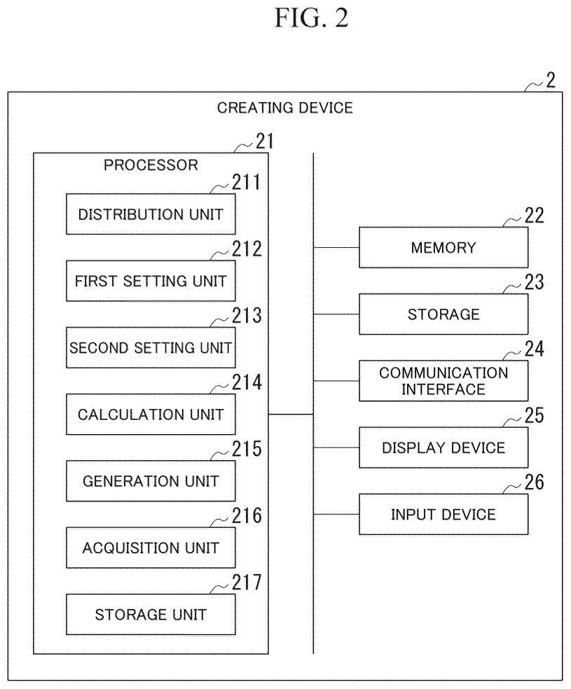

FIG. 2 is a block diagram showing a functional configuration of the creating device 2 according to some example embodiments of the present disclosure.

As shown in FIG. 2, the creating device 2 includes a processor 21, a memory 22, a storage 23, a communication interface 24, a display device 25, and an input device 26.

The processor 21 operates in accordance with a predetermined program to function as a distribution unit 211, a first setting unit 212, a second setting unit 213, a calculation unit 214, a generation unit 215, an acquisition unit 216, and a storage unit 217.

The distribution unit 211 determines a plurality of centers, as shown in FIG. 5. At that time, IDs are distributed to the plurality of centers.

The distribution unit 211 may randomly determine the plurality of centers.

The first setting unit 212 sets a correlation distance R, which will be described later, for each center.

The first setting unit 212 may set the correlation distance R based on data stored in the storage unit 217, which will be described later.

The second setting unit 213 sets nanorods for other centers based on the correlation distance R and a center-to-center distance CD, which is the distance between one center and another center.

The second setting unit 213 sets the length and orientation of the nanorod using the plurality of centers set by the distribution unit 211 as the center positions of the nanorods. For example, the length of the nanorod may be set in the second setting unit 213 in advance.

When setting nanorods, the second setting unit 213 performs processing in accordance with the order of IDs distributed to the plurality of centers.

The second setting unit 213 sets nanorods with a random orientation with respect to each center in accordance with the order of IDs. However, in the following case, the second setting unit 213 sets nanorods with a predetermined orientation with respect to each center.

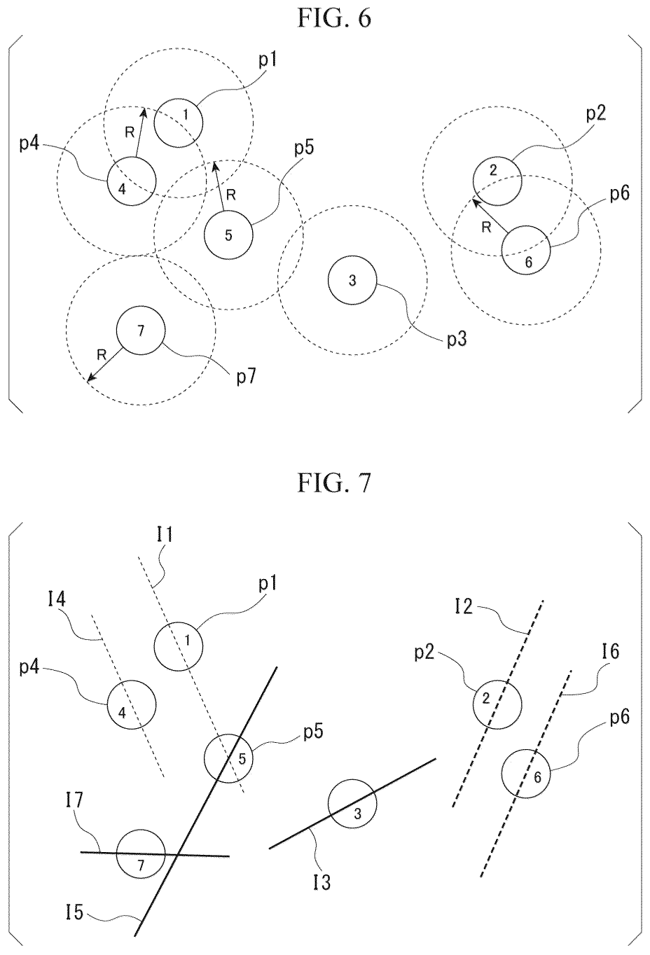

As shown in FIG. 6, the second setting unit 213 draws a circle from each center with the correlation distance R set by the first setting unit 212 as a radius when setting the nanorods. Thereafter, a case is assumed in which another center having an ID previous to an ID of each center is included on the circle or within the circle. That is, a case is assumed in which another center having a previous ID is present within a correlation distance R of each center. In that case, the second setting unit 213 orients a nanorod that is set for each center so that an angle θ (0≤θ≤90°) between the nanorod set for each center and a nanorod set at another center becomes a designated angle. The angle designated in the second setting unit 213 is, for example, 0°.

Thus, when an ID previous to an ID of each center is present within the set correlation distance R, the orientation of a nanorod set for each ID of each center is affected by the orientation of the previous ID.

When a plurality of other centers having a previous ID are present within a correlation distance R of each center, the second setting unit 213 may determine an angle of a nanorod that is set for each center from a weighted average of a straight line related to nanorods that are set at the plurality of other centers within the correlation distance R.

As described above, the network structure D1 of the data element D is created by setting nanorods across a plurality of centers.

The network structure D1 may be stored as an image in the storage unit 217, which will be described later.

The calculation unit 214 calculates a combined resistance value of the network structure D1 of the data elements D created by the second setting unit 213. At this time, a state is assumed in which the two electrodes D2 of the data element D are electrically connected to each other to cover the end faces at both the right and left ends of the network structure D1, as shown in FIG. 1.

For example, the calculation unit 214 calculates the combined resistance value of the network structure D1 by using Kirchhoff's law and replacing the network structure D1 with an equivalent circuit.

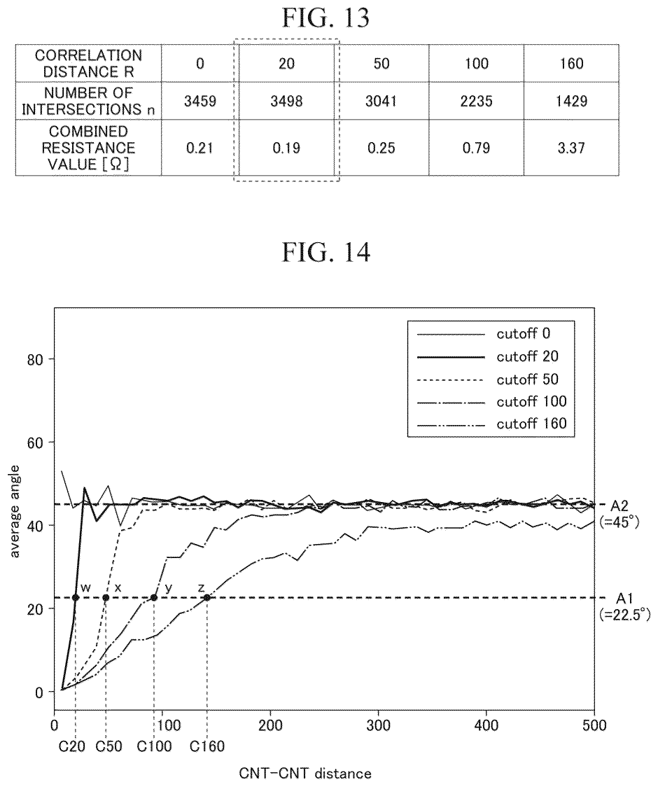

The generation unit 215 creates a table showing a relationship between the correlation distance R that is set by the first setting unit 212 and the resistance value calculated by the calculation unit 214. At that time, the generation unit 215 may calculate a resistance value for each of the different correlation distances R and create a table as shown in FIG. 13 by changing the correlation distance R that is set in the first setting unit 212 in ST22.

For example, as shown in FIG. 13, in addition to the relationship between the correlation distance R and the combined resistance value, the generation unit 215 may describe the number of intersections n between the plurality of constituent elements that constitute the network structure D1 of the data element D. By adding the description of the number of intersections n, the operator can ascertain that the number of intersections n changes depending on the settings of the correlation distance R, a contact area between the plurality of constituent elements increases due to an increase in the number of intersections n, the amount of current flowing through the network structure D1 increases, and the resistance value decreases.

The acquisition unit 216 acquires data from the storage unit 217.

The storage unit 217 stores the correlation distance R that is set by the first setting unit 212 of the creating device 2 and an image of the network structure D1. For example, the storage unit 217 may store various data acquired in the past by the extraction device 3.

The storage unit 217 stores the combined resistance value calculated by the calculation unit 214 and the table created by the generation unit 215.

A predetermined program executed by the processor 21 is stored in a computer-readable recording medium. The computer-readable recording medium is a magnetic disk, a magneto-optical disk, a CD-ROM, a DVD-ROM, a semiconductor memory, or the like. This computer program may be distributed to a computer via a communication line, and the computer receiving the distribution may execute the program. Furthermore, this program may be a program for realizing some of the functions described above. Furthermore, the program may be a so-called difference file (difference program) that can realize the above-described functions in combination with a program already recorded in a computer system.

The memory 22 has a memory area necessary for the operation of the processor 21.

The storage 23 is a so-called auxiliary storage device, and is, for example, a hard disk drive (HDD), a solid state drive (SSD), or the like.

The communication interface 24 is an interface for transmitting and receiving various signals to and from external equipment (such as the extraction device 3).

The display device 25 is a display device that displays calculation results and the like, and is, for example, a liquid crystal display or an organic EL display.

The input device 26 is an input device that receives operations from a user of the creating device 2, and is, for example, a general mouse, a general keyboard, a general touch sensor, or the like.

### Functional Configuration of Extraction Device

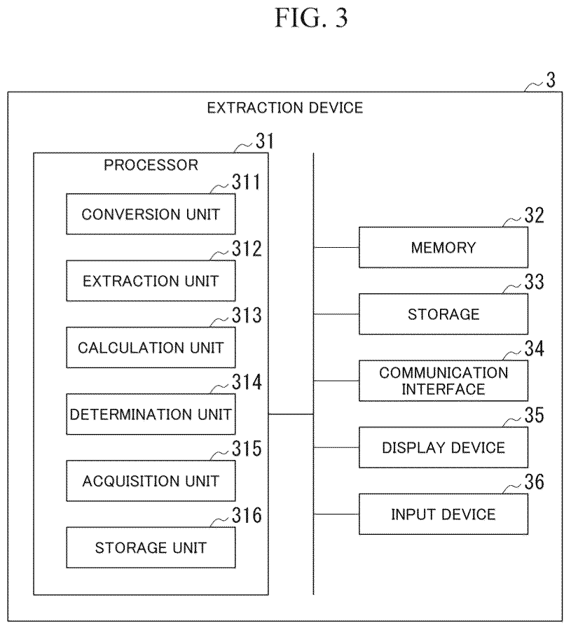

FIG. 3 is a block diagram showing a functional configuration of the extraction device 3 according to some example embodiments of the present disclosure.

As shown in FIG. 3, the extraction device 3 includes a processor 31, a memory 32, a storage 33, a communication interface 34, a display device 35, and an input device 36.

The processor 31 operates in accordance with a predetermined program to function as a conversion unit 311, an extraction unit 312, a calculation unit 313, a determination unit 314, an acquisition unit 315, and a storage unit 316.

The conversion unit 311 approximates each constituent element 51a, which is present in an image captured by the imaging device 4, to a nanorod.

For example, the conversion unit 311 allocates a plurality of nanorods which are segments, in consideration of the degree of curvature of each constituent element 51a from an image captured from the top surface of the network structure 51, and the conversion unit 311 approximates each constituent element 51a to the nanorod so that the constituent element 51a is constituted by a plurality of segments.

For example, when the conversion unit 311 approximates each constituent element 51a to the nanorod, the conversion unit 311 approximates the constituent element 51a using a nanorod having a specific thickness.

At that time, in order to confirm the approximation of the nanorod, the operator may compare a captured image processed by the conversion unit 311 of the extraction device 3 with an image obtained by capturing the data element D created by the creating device 2.

The extraction unit 312 extracts a plurality of nanorods based on an image of the network structure 51 including a plurality of constituent elements 51a approximated to a plurality of nanorods.

For example, the extraction unit 312 extracts a plurality of nanorods approximated by the conversion unit 311 from a captured image.

The calculation unit 313 creates a plurality of pairs from nanorods extracted by the extraction unit 312, calculates the distance between each pair of nanorods and an angle θ formed by each pair, which will be described later, and acquires data. In an example according to the present example embodiments, the calculation unit 313 calculates a center-to-center distance CD as the distance between the nanorods and acquires data.

The calculation unit 313 divides the entire range in which the acquired center-to-center distance CD is distributed into a plurality of specific ranges as a representative angle, and totalizes an average value which is a representative value of the angle θ formed by each pair acquired for the plurality of pairs having a center-to-center distance CD in each specific range.

The calculation unit 313 totalizes the lengths of all of the extracted nanorods and calculates an average length. For example, the unit of the calculated average length may be a dimensionless quantity such as a pixel.

The determination unit 314 determines a correlation distance R based on a relationship between the center-to-center distance CD of each pair and the angle θ formed by each pair.

For example, as shown in FIG. 14, the determination unit 314 creates a graph showing the relationship between the center-to-center distance and the average angle, which includes information on the totalized average value of the angle θ for each center-to-center distance CD, as an average angle. The determination unit 314 sets a predetermined average angle from this graph, and determines a center-to-center distance CD that intersects this value as a correlation distance R.

The acquisition unit 315 acquires data from the storage unit 316.

The storage unit 316 stores the center-to-center distance CD of each pair obtained by the calculation unit 313, the angle θ formed by each pair, and the average length of all of the extracted nanorods. The storage unit 316 also stores a graph showing a relationship between the center-to-center distance CD and the average angle.

The storage unit 316 stores the correlation distance R determined by the determination unit 314.

The predetermined program executed by the processor 31 is stored in a computer-readable recording medium. The computer-readable recording medium is a magnetic disk, a magneto-optical disk, a CD-ROM, a DVD-ROM, a semiconductor memory, or the like. This computer program may be distributed to a computer via a communication line, and the computer receiving the distribution may execute the program. Furthermore, this program may be a program for realizing some of the functions described above. Furthermore, the program may be a so-called difference file (difference program) that can realize the above-described functions in combination with a program already recorded in a computer system.

The memory 32 has a memory area necessary for the operation of the processor 31.

The storage 33 is a so-called auxiliary storage device, and is, for example, a hard disk drive (HDD), a solid state drive (SSD), or the like.

The communication interface 34 is an interface for transmitting and receiving various signals to and from external equipment (such as the creating device 2 and the imaging device 4).

The display device 35 is a display device that displays an analytical image in which the network structure 51 is approximated to a nanorod, the determined correlation distance, and the like, and is, for example, a liquid crystal display or an organic EL display.

The input device 36 is an input device that receives operations from a user of the extraction device 3, and is, for example, a general mouse, a general keyboard, a general touch sensor, or the like.

### Data Creation Method

A data creation method of the creating device 2 in some example embodiments of the present disclosure will be described.

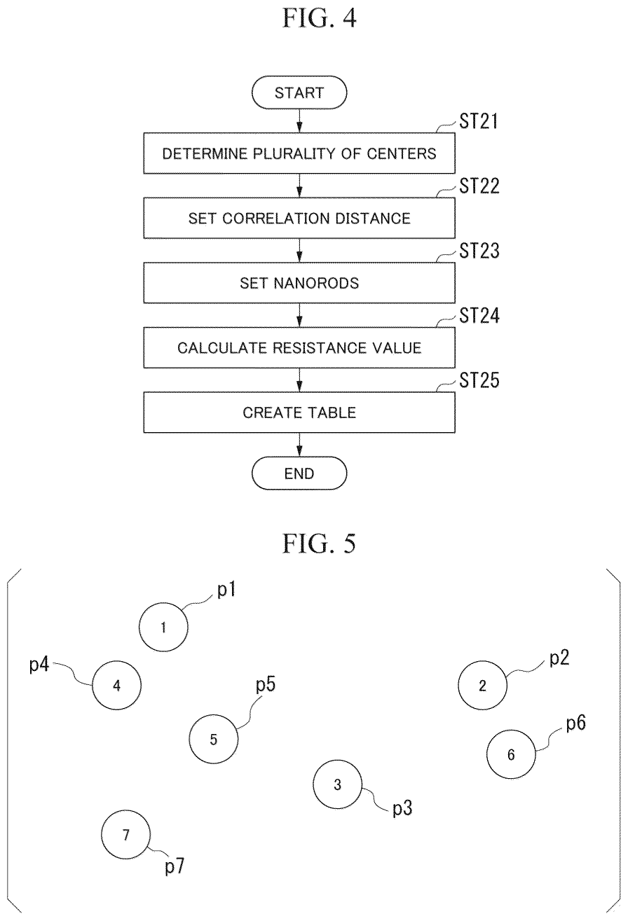

The data creation method of the creating device 2 in some example embodiments of the present disclosure is performed in accordance with a flow shown in FIG. 4.

First, the distribution unit 211 of the creating device 2 determines a plurality of centers, as shown in FIG. 5. At this time, IDs (p1 to p6) are distributed to the plurality of centers.

The distribution unit 211 may randomly determine the plurality of centers (ST21).

Next, the first setting unit 212 of the creating device 2 sets a correlation distance R for each center.

The correlation distance R can be set as appropriate by the operator or the first setting unit 212 of the creating device 2, and determines the degree of orientation of the network structure D1 in ST23.

The first setting unit 212 may set the correlation distance R based on data stored in the storage unit 217 (ST22).

Next, the second setting unit 213 of the creating device 2 sets nanorods for other centers based on the correlation distance R and the center-to-center distance CD, which is the distance between one center and another center.

The second setting unit 213 sets the length and orientation of the nanorod using the plurality of centers set by the distribution unit 211 as the center positions of the nanorods. For example, the length of the nanorod may be set in the second setting unit 213 in advance.

When setting nanorods, the second setting unit 213 performs processing in ascending order in accordance with the order of IDs (p1 to p6) distributed to the plurality of centers.

The second setting unit 213 sets nanorods by a random orientation with respect to each center in accordance with the order of IDs (p1 to p6). However, in the following cases, the second setting unit 213 sets nanorods with a predetermined orientation with respect to each center.

As shown in FIG. 6, the second setting unit 213 draws a circle from each center with the correlation distance R set by the first setting unit 212 as a radius when setting the nanorods. Thereafter, a case is assumed in which another center having an ID previous to an ID of each center is included on the circle or within the circle. That is, a case is assumed in which another center having a previous ID is present within a correlation distance R of each center. In that case, the second setting unit 213 orients a nanorod that is set for each center so that an angle θ (0≤θ≤90°) between the nanorod set for each center and a nanorod set at another center becomes a designated angle (ST23). The angle designated in the second setting unit 213 is, for example, 0°.

Thus, when an ID previous to an ID of each center is present within the set correlation distance R, the orientation of a nanorod set for each ID at each center is affected by the orientation of the previous ID.

For example, for each center (ID: p1, p2, p3), there is no other center having an ID previous to the ID of the center within a correlation distance R. For this reason, the second setting unit 213 sets nanorods (I1, I2, I3) with random orientations at the centers (ID: p1, p2, p3).

For each center (ID: p4), there is another center (ID: p1) having an ID previous to the ID of the center within a correlation distance R. For this reason, the second setting unit 213 orients a nanorod so that an angle θ (0≤θ≤90°) formed by a nanorod (I4) set for each center (ID: p4) and the nanorod (I1) set for another center (ID: p1) is set to be a designated angle. In FIG. 7, since the angle designated in the second setting unit 213 is 0°, the nanorod I4 is set along the nanorod I1.

For each center (ID: p5), there is no other center having an ID previous to the ID of the center within a correlation distance R. Other centers (ID: p1, p3, p4) having IDs previous to each center (ID: p5) are present at a close distance to each center (ID: p5), but they are not present within the correlation distance R of each center (ID: p5). For this reason, the second setting unit 213 sets a nanorod (I5) with each center (ID: p5) randomly oriented.

For each center (ID: p6), there is another center (ID: p2) having an ID previous to the ID of the center within a correlation distance R. For this reason, the second setting unit 213 orients a nanorod so that an angle θ (0≤θ≤90°) formed by a nanorod (I6) set for each center (ID: p6) and the nanorod (I2) set for another center (ID: p2) is set to be a designated angle. Since the angle θ between I2 and I6 which is designated in the second setting unit 213 is 0°, the nanorod I6 is set along the nanorod I2.

For each center (ID: p7), there is no other center having an ID previous to the ID of the center within a correlation distance R. For this reason, the second setting unit 213 sets a nanorod (I7) with a random orientation similar to other centers (ID: p5).

When a plurality of other centers having a previous ID are present within a correlation distance R of each center, the second setting unit 213 may determine an angle of a nanorod that is set for each center from a weighted average of a straight line related to nanorods that are set for the plurality of other centers within the correlation distance R.

As described above, the network structure D1 of the data elements D is created by setting nanorods across a plurality of centers.

This network structure D1 may be stored in the storage unit 217 as an image.

Next, the calculation unit 214 of the creating device 2 calculates a combined resistance value of the network structure D1 of the data element D created by the creating device 2 (ST24).

When calculating the combined resistance value of the network structure D1, it is assumed that the two electrodes D2 of the data element D are electrically connected to each other so as to cover the end faces at both the right and left ends of the network structure D1.

For example, the calculation unit 214 calculates the combined resistance value of the network structure D1 by using Kirchhoff's law and replacing the network structure D1 with an equivalent circuit.

Next, the generation unit 215 of the creating device 2 creates a table showing a relationship between the correlation distance R that is set by the first setting unit 212 and the resistance value calculated by the calculation unit 214. At that time, the generation unit 215 may calculate a resistance value for each of the different correlation distances R and create a table as shown in FIG. 13 by changing the correlation distance R that is set in the first setting unit 212 in ST22 (ST25).

Here, the data creation performed by the creating device 2 is completed.

### Completion

The display device 25 displays a table showing a relationship between a correlation distance R and a resistance value created by the generation unit 215.

For example, as shown in FIG. 13, in addition to the relationship between the correlation distance R and the combined resistance value, the generation unit 215 may describe the number of intersections n between the plurality of constituent elements that constitute the network structure D1 of the data element D. By adding the description of the number of intersections n, the operator can ascertain that the number of intersections n changes depending on the settings of the correlation distance R, a contact area between the plurality of constituent elements increases due to an increase in the number of intersections n, the amount of current flowing through the network structure D1 increases, and the resistance value decreases.

The storage unit 217 of the creating device 2 stores the correlation distance R that is set by the first setting unit 212, the combined resistance value calculated by the calculation unit 214, and the table created by the generation unit 215. For example, the storage unit 217 may store various data acquired in the past by the extraction device 3. Thereby, the acquisition unit 216 can call data such as past correlation distances from the storage unit 217 at any timing.

### Correlation Distance Extraction Method

The data creation method of the extraction device 3 in some example embodiments of the present disclosure will be described.

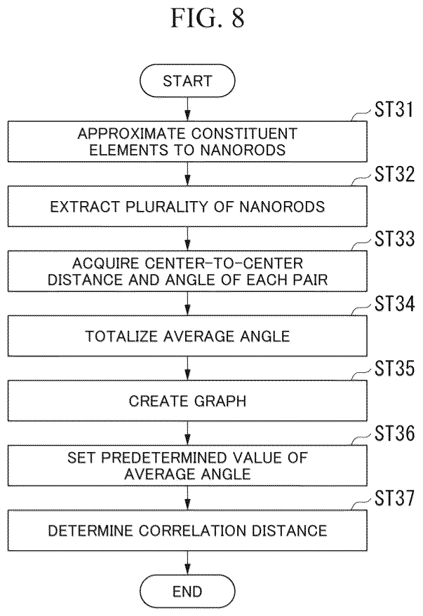

The data creation method of the extraction device 3 in some example embodiments of the present disclosure is performed in accordance with a flow shown in FIG. 8.

First, the conversion unit 311 of the extraction device 3 approximates each constituent element 51a present in an image captured by the imaging device 4 to a nanorod.

For example, the conversion unit 311 allocates a plurality of nanorods which are segments, in consideration of the degree of curvature of each constituent element 51a from an image captured from the top surface of the network structure 51, and approximates each constituent element 51a to the nanorod so that the constituent element 51a is constituted by a plurality of segments (ST31).

For example, when the conversion unit 311 approximates each constituent element 51a to the nanorod, the conversion unit 311 approximates the constituent element 51a to a nanorod having a specific thickness. The constituent elements 51a may have different thicknesses. For this reason, it is possible to facilitate the acquisition of a distance between nanorods by approximating the constituent element 51a to a nanorod having a specific thickness.

At that time, in order to confirm the approximation of the nanorods, the operator may compare a captured image processed by the conversion unit 311 of the extraction device 3 with an image obtained by capturing the data element D created by the creating device 2.

In the example present embodiments, in order to show a relationship between data obtained by the processing of the extraction device 3 and a correlation distance R, an image obtained by capturing the data element D created by the creating device 2 is used as a captured image.

Next, the extraction unit 312 of the extraction device 3 extracts a plurality of nanorods based on an image of the network structure 51 that includes a plurality of constituent elements 51a that are approximated to a plurality of nanorods.

For example, the extraction unit 312 extracts a plurality of nanorods approximated by the conversion unit 311 from a captured image (ST32).

Next, the calculation unit 313 of the extraction device 3 creates a plurality of pairs from the nanorods extracted by the extraction unit 312, calculates the distance between each pair of nanorods and an angle θ formed by each pair, and acquires data (ST33). In an example according to the present example embodiments, the calculation unit 313 calculates a center-to-center distance CD as a distance between nanorods, and acquires data.

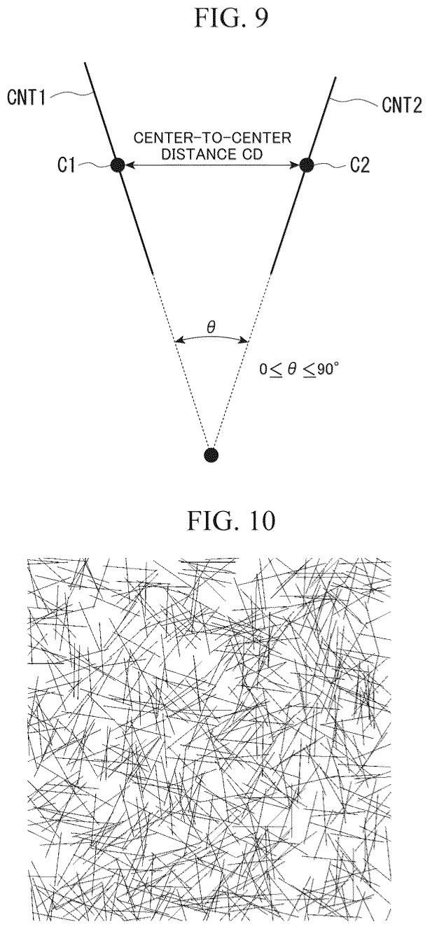

As shown in FIG. 9, the center-to-center distance CD means a distance between midpoints (C1, C2) of nanorods (CNT1, CNT2) approximated by the conversion unit 311. The calculation unit 313 calculates a center-to-center distance CD and an angle θ (0≤θ≤90°) formed by each pair (CNT1, CNT2) of the approximated nanorods, and acquires data.

The number of pairs Pᵣ with respect to the number of nanorods r (r≥2) is expressed as shown in the following Equation (1). The calculation unit 313 sets a plurality of pairs for the nanorods, and calculates center-to-center distances CD of pair thereof and the angles θ (0≤θ≤90°) formed thereby.

$${P}_{r} = \frac{r ( r - 1 )}{2} \qquad ( 1 )$$

The number of pairs with respect to the number of rods r. r≥2

Next, the calculation unit 313 of the extraction device 3 divides the entire range in which the acquired center-to-center distances CD are distributed into a plurality of specific ranges as a representative angle, and totalizes an average value which is a representative value of the angle θ (0≤θ≤90°) formed by each pair acquired for the plurality of pairs having center-to-center distances CD in each specific range (ST34). The calculation unit 313 totalizes the lengths of all of the extracted nanorods and calculates the average length. For example, the unit of the calculated average length may be a dimensionless quantity such as a pixel.

Next, as shown in FIG. 14, the determination unit 314 of the extraction device 3 creates, as an average angle, a graph showing the relationship between the center-to-center distance and the average angle, which includes information obtained by totaling the average angle of each pair of nanorods (ST35).

Next, the determination unit 314 of the extraction device 3 sets a predetermined average angle from the graph (ST36), and determines a center-to-center distance CD that intersects this value as a correlation distance R (ST37).

For example, the correlation distance R of the network structure 51 may be a center-to-center distance when the average angle, which is the average value of angles formed by pairs of nanorods with the same center-to-center distance, is a predetermined average angle of 22.5°.

Thereby, the determination unit 314 of the extraction device 3 determines the correlation distance R based on the relationship between the center-to-center distance CD and the angle θ. (completion)

The display device 35 displays a graph showing the relationship between the center-to-center distance CD and the average angle created by the determination unit 314 and a correlation distance R determined by the determination unit 314.

The storage unit 316 of the extraction device 3 stores the above-described graph created by the determination unit 314, the center-to-center distance CD of each pair and the angle θ formed by each pair which are acquired by the calculation unit 313, and the average length of all of the extracted nanorods. In addition, the storage unit 316 stores the correlation distance R determined by the determination unit 314. Thereby, the acquisition unit 315 can call data such as past graphs from the storage unit 316 at any timing.

### Evaluation System

The evaluation system 1 can display information regarding the network structure D1 of the data element D created by the creating device 2 and information regarding the network structure 51 of the element 5 extracted by the extraction device 3. Thereby, the operator can evaluate correlation distances R obtained by the creating device 2 and the extraction device 3, images showing the degree of orientation obtained by the creating device 2 and the extraction device 3, a table regarding the network structure D1 of the data element D created by the creating device 2, and a graph regarding the network structure 51 of the element 5 created by the extraction device 3, and can perform preliminary examination for reducing the resistance of the network structure 51. The evaluation system 1 may display data stored in the storage unit 217 of the creating device 2 or the storage unit 316 of the extraction device 3.

The evaluation system 1 displays, on the display device 25, a table showing a relationship between the correlation distance R and the overall resistance value of the network structure D1 created by the generation unit 215, and an image of the network structure D1.

The evaluation system 1 displays, on the display device 35, a graph showing a relationship between a center-to-center distance and an average angle created by the determination unit 314, a correlation distance R determined by the determination unit 314, and a captured image of the network structure 51.

The operator can examine an optimal orientation of the network structure 51 for reducing the resistance of the network structure 51 based on data displayed on the display device 25 and the display device 35.

For example, the evaluation system 1 may transmit and receive captured image data between the creating device 2 and the extraction device 3.

The evaluation system 1 is also used by the operator to confirm the approximate state of the nanorods in the extraction device 3. For example, the extraction device 3 may use an image obtained by capturing the data element D created by the creating device 2 as a captured image. Thereby, the operator can compare a captured image processed by the extraction device 3 with an image obtained by capturing the data element D created by the creating device 2 in the evaluation system 1, and can confirm the approximation of nanorods.

### Operations and Effects

According to the extraction device 3 of the present example embodiments, it is possible to approximate the plurality of constituent elements 51a in the network structure 51 to a plurality of nanorods by using an image obtained by capturing the network structure 51 of the element 5 to extract the nanorods, and to acquire a center-to-center distance and an angle between each pair of the plurality of nanorods. It is possible to ascertain the orientation of the network structure 51 by determining a correlation distance R based on a relationship between an acquired center-to-center distance CD and angle θ. Since the orientation of the network structure 51 affects electrical resistance, it is possible to associate the orientation of the network structure 51 and the electrical resistance with each other by quantitatively ascertaining the orientation of the network structure 51 by the extraction device 3, and to evaluate the overall resistance value of the network structure 51.

Thus, the extraction device according to the disclosure can easily lower the electrical resistance of the network structure 51.

According to an example of the present example embodiments, the electrical resistance of the network structure 51 including carbon nanotubes, which has a high electrical resistance that is still too high to be applied to the element 5, can be evaluated from the viewpoint of the degree of orientation of the carbon nanotubes using a correlation distance R.

In an example of the present example embodiments, the extraction device 3 approximates the plurality of constituent elements 51a in the network structure 51 to a plurality of nanorods by using the image of the network structure 51 to extract the nanorods, and acquires a center-to-center distance CD and an angle θ of each of pairs of the plurality of nanorods. It is possible to evaluate the orientation of the network structure 51 by determining a correlation distance R based on the relationship between the acquired center-to-center distance and angle.

Thus, it is easy to lower the electrical resistance of the network structure 51.

### Modification Example

The constituent element 51a is not limited to a nanocarbon, and the constituent element 51a may have a network structure and may be a rod-shaped element. The distance between nanorods may be a closest distance Lm instead of a center-to-center distance CD.

The closest distance Lm is shown in FIGS. 20 to 22.

As shown in FIG. 20, the closest distance Lm is the closest distance between nanorods in a pair of nanorods (CNT1, CNT2) approximated by the conversion unit 311.

The extraction unit 312 of the extraction device 3 may set the distance between an end e1 of one nanorod (CNT1) and an end e2 of the other nanorod (CNT2) as the closest distance Lm.

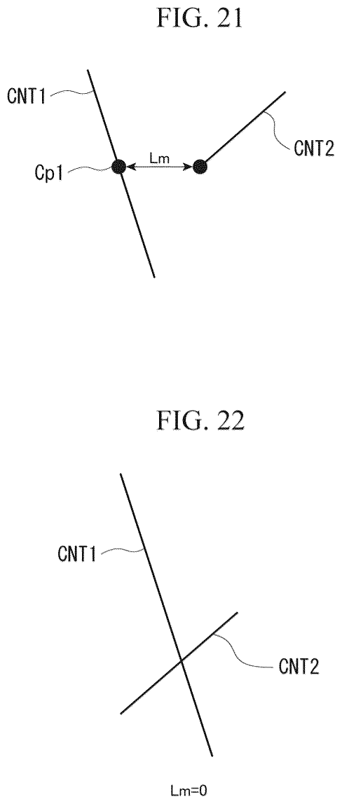

As shown in FIG. 21, the extraction unit 312 may set a distance between a certain point Cp1 on one nanorod (CNT1) and the end e2 of the other nanorod (CNT2) to be the closest distance Lm.

As shown in FIG. 22, the closest distance Lm is the shortest distance between a pair of nanorods, and thus, when one nanorod (CNT1) and the other nanorod (CNT2) come into contact with each other, the extraction unit 312 of the extraction device 3 may set the closest distance Lm to 0.

In the above-described example embodiments, the determination unit 314 sets an average angle at each center-to-center distance CD as a representative angle. However, a representative angle is not limited to the average angle, and any angle may be used as a representative angle as long as it is a representative value of an angle θ at each center-to-center distance CD.

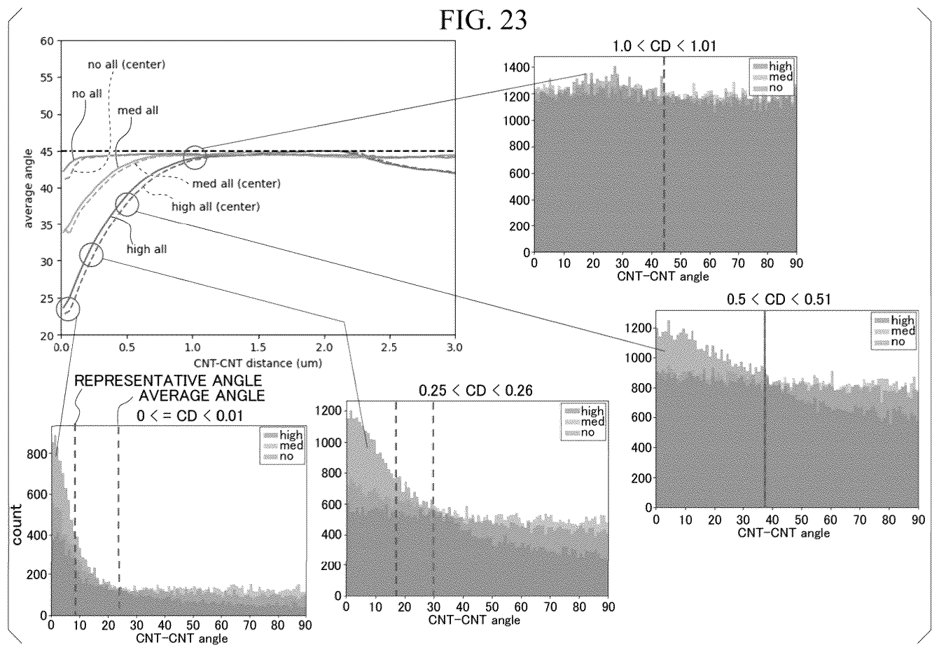

For example, the determination unit 314 may set another angle different from the average angle as a representative angle, as shown in distributions in FIG. 23. In the distributions as shown in FIG. 23, as a center-to-center distance CD increases, a (cut) normal distribution whose center is at 0° approaches a uniform distribution while increasing a standard deviation. In such a case, especially when a center-to-center distance CD is short, it is difficult to reflect the characteristics of such a distribution in an “average angle”.

On the other hand, in the case of a representative angle as shown in FIG. 23, it is easy to reflect the characteristics of such a distribution. For example, the calculation unit 313 may totalize an angle θ formed by each pair of nanorods for a distance between nanorods in a specific range. The determination unit 314 may estimate a (cut) normal distribution using the angles totalized by the calculation unit 313. After estimating the normal distribution (cutting with 0° as a cutting edge), the determination unit 314 may calculate the standard deviation with respect to 0° and may set a value obtained by adding the standard deviation to 0° as a representative angle.

For example, the determination unit 314 may set a median value of the angle θ totalized by the calculation unit 313 as a representative angle.

A correlation distance R is not limited to a case where a predetermined average angle of 22.5° is set.

For example, when an average angle is determined in a graph of FIG. 23, an average angle in the vicinity of 41° to 42° can be used.

Hereinafter, some example embodiments of the creating device according to the disclosure will be described using FIG. 15.

### Configuration

A creating device 70 includes a distribution unit 701 that determines a plurality of centers, a first setting unit 702 that sets a correlation distance for each center, and a second setting unit 703 that sets nanorods for other centers based on a correlation distance and a center-to-center distance which is the distance between one center and another center.

### Operations and Effects

According to the present example embodiments, the first setting unit 702 sets a correlation distance from the plurality of centers determined by the distribution unit 701, and the second setting unit 703 sets nanorods based on the correlation distance and center-to-center distances between the plurality of centers. The orientation of a network structure is determined based on the correlation distance and the center-to-center distances. Since the orientation of the network structure changes depending on the correlation distance, the orientation of the network structure that achieves a low resistance value can be estimated from the correlation distance by calculating the resistance value of the network structure.

Thus, it is easy to lower the electrical resistance of the network structure.

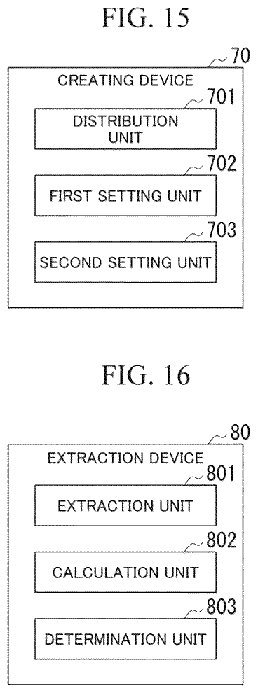

Hereinafter, some example embodiments of the extraction device according to the disclosure will be described using FIG. 16.

### Configuration

An extraction device 80 includes an extraction unit 801 that extracts a plurality of nanorods based on an image of a network structure including a plurality of constituent elements approximated to the plurality of nanorods, a calculation unit 802 that acquires an inter-nanorod distance and an angle between each pair of the plurality of nanorods, and a determination unit 803 that determines a correlation distance based on a relationship between the inter-nanorod distance and the angle.

### Operations and Effects

According to the present example embodiments, a plurality of constituent elements in a network structure are approximated to a plurality of nanorods by using the image to extract the nanorods, and an inter-nanorod distance and an angle between each pair of the plurality of nanorods are acquired. It is possible to ascertain the orientation of the network structure by determining a correlation distance based on a relationship between the acquired distance and angle between nanorods. Since the orientation of the network structure affects electrical resistance, it is possible to associate the orientation of the network structure and the electrical resistance with each other by quantitatively ascertaining the orientation of the network structure by the extraction device 80, and to evaluate the overall resistance value of the network structure.

Thus, it is easy to lower the electrical resistance of the network structure.

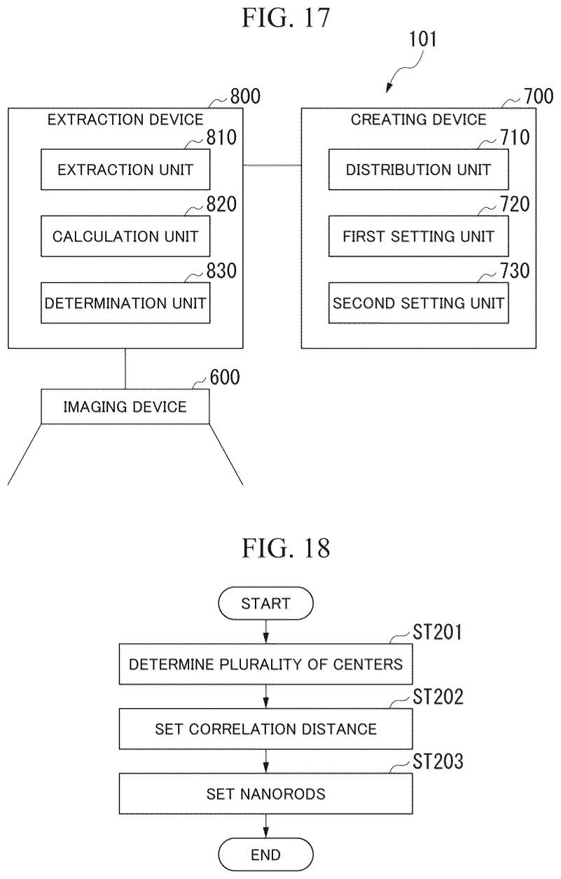

Hereinafter, some example embodiments of the evaluation system according to the disclosure will be described using FIG. 17.

### Configuration

An evaluation system 101 includes an imaging device 600, an extraction device 800, and a creating device 700. The imaging device 600 images a network structure including a plurality of constituent elements. The extraction device 800 includes an extraction unit 810 that extracts a plurality of nanorods based on an image of the network structure including the plurality of constituent elements approximated to a plurality of nanorods, a calculation unit 820 that acquires an inter-nanorod distance and an angle between each pair of the plurality of nanorods, and a determination unit 830 that determines a correlation distance based on a relationship between the inter-nanorod distance and the angle. The creating device 700 includes a distribution unit 710 that determines a plurality of centers, a first setting unit 720 that sets a correlation distance for each center, and a second setting unit 730 that sets nanorods for other centers based on the correlation distance and a center-to-center distance which is the distance between one center and another center.

### Operations and Effects

According to the present example embodiments, a plurality of constituent elements in a network structure are approximated to a plurality of nanorods using an image captured by the imaging device 600 to extract the nanorods, and an inter-nanorod distance and an angle between each pair of the plurality of nanorods are acquired. It is possible to ascertain the orientation of the network structure by determining a correlation distance based on a relationship between the acquired distance and angle between nanorods. Since the orientation of the network structure affects electrical resistance, it is possible to associate the orientation of the network structure and the electrical resistance with each other by quantitatively ascertaining the orientation of the network structure by the extraction device 800, and to evaluate the overall resistance value of the network structure. By performing comparison with the network structure created by the creating device 700, an operator can ascertain a difference from the actual network structure and examine an optimal network structure for reducing resistance.

Thus, it is easy to lower the electrical resistance of the network structure.

Hereinafter, some example embodiments of the data creation method according to the disclosure will be described using FIG. 18.

The data creation method in the present example embodiments is performed according to a flow shown in FIG. 18.

The data creation method includes a step of determining a plurality of centers (ST201), a step of setting a correlation distance for each center (ST202), and a step of setting nanorods for other centers based on a center-to-center distance which is the distance between one center and another center (ST203).

### Operations and Effects

According to the data creation method of the present example embodiments, a correlation distance is set from a plurality of centers determined, and nanorods are set based on the correlation distances and center-to-center distances between the plurality of centers. The orientation of a network structure is determined based on the correlation distance and the center-to-center distances. Since the orientation of the network structure changes depending on the correlation distance, the orientation of the network structure that achieves a low resistance value can be estimated from the correlation distance by calculating the resistance value of the network structure.

Thus, according to the data creation method in the disclosure, it is easy to reduce the electrical resistance of the network structure.

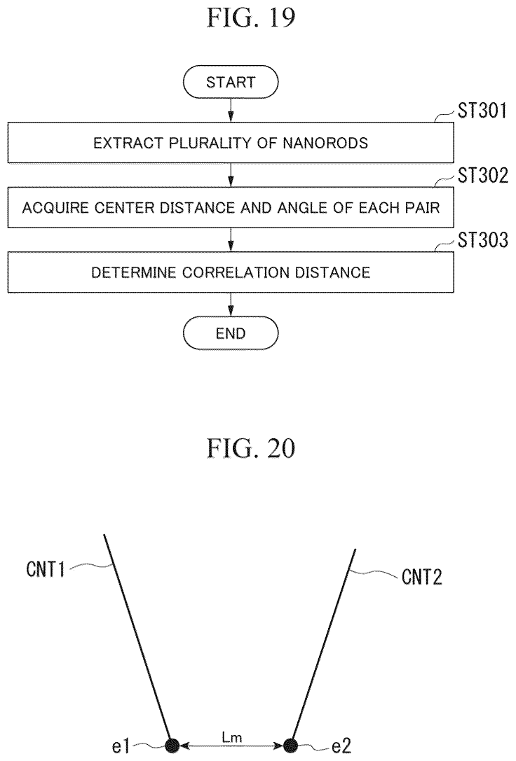

Hereinafter, some example embodiments of the correlation distance extraction method according to the disclosure will be described using FIG. 19.

The correlation distance extraction method in the present example embodiments is performed according to a flow shown in FIG. 19.

The correlation distance extraction method includes a step of extracting a plurality of nanorods based on an image of a network structure including a plurality of constituent elements approximated to the plurality of nanorods (ST301), a step of acquiring an inter-nanorod distance and an angle between each pair of the plurality of nanorods (ST302), and a step of determining a correlation distance based on the relationship between the inter-nanorod distance and the angle (ST303).

### Operations and Effects

According to the correlation distance extraction method of the present example embodiments, a plurality of constituent elements in a network structure are approximated to a plurality of nanorods by using the image to extract the nanorods, and an inter-nanorod distance and an angle between each pair of the plurality of nanorods are acquired. It is possible to ascertain the orientation of the network structure by determining the correlation distance based on the relationship between the acquired distance and the angle between nanorods. Since the orientation of the network structure 51 affects the electrical resistance, it is possible to associate the orientation of the network structure and the electrical resistance with each other by quantitatively ascertaining the orientation of the network structure by the extraction method, and to evaluate the overall resistance value of the network structure.

Thus, according to the correlation distance extraction method in the disclosure, it is easy to reduce the electrical resistance of the network structure.

Hereinafter, effects of the disclosure will be described more specifically using an example. Conditions in the example are an example of conditions adopted to confirm feasibility and effects of the disclosure, and the disclosure is not limited to this example of conditions. The disclosure may adopt various conditions as long as the object of the disclosure is achieved without departing from the gist of the disclosure.

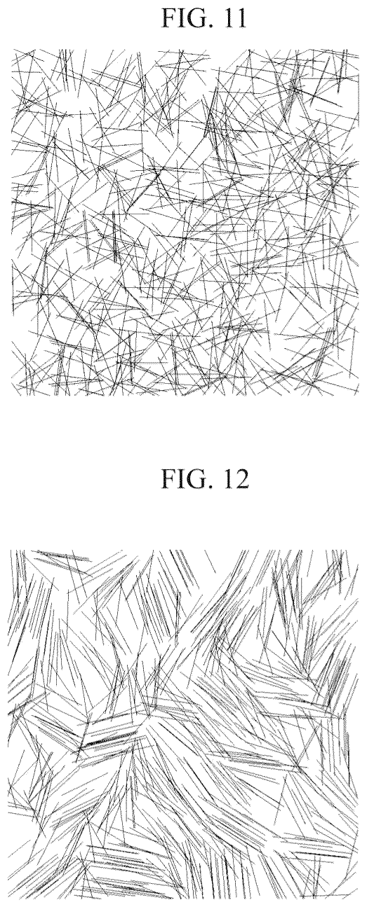

In the nanorods shown in FIGS. 10 to 12, 700 nanorods with a length of 300 pixels were oriented in a certain area by the creating device 2. FIG. 10 shows a correlation distance of 0, FIG. 11 shows a correlation distance of 20, and FIG. 12 shows a correlation distance of 160. In the nanorods shown in FIGS. 10 to 12, it could be confirmed that the orientation of the nanorods themselves changed depending on a correlation distance.

FIG. 13 is a diagram showing the relationship between the correlation distance and the resistance value of the network structure D1. According to the drawing, it was confirmed that the number of intersections n increased and the resistance value decreased with respect to the correlation distance of 0 in a certain correlation distance R (the correlation distance of 20 in FIG. 11), rather than a case where the number of intersections n decreased and the resistance value increased as the value of a correlation distance R increases.

It was confirmed from FIGS. 10 to 12 that there was a difference in the degree of orientation of the network structure D1 depending on the correlation distance R in FIG. 13.

FIG. 14 is a graph created by the extraction device 3.

In FIG. 14, cutoff 0 indicated that a correlation distance R of the data element D created by the creating device 2 was 0, and the same applied to the other graphs (Cutoff 20, Cutoff 50, Cutoff 100, Cutoff 160).

The calculation unit 313 of the extraction device 3 set a plurality of pairs for nanorods at a certain center-to-center distance CD and calculated center-to-center distances CD between the pairs and an angle θ formed by the nanorods, and obtained data. When the obtained data was summarized, a graph shown in FIG. 14 was drawn.

In FIG. 14, an average angle A2 was 45°. It could be read that, in the cutoff 0, when a center-to-center distance CD (CNT-CNT distance) between paired nanorods increased, an angle θ (0≤θ≤90°) formed by the nanorods could take an average angle of 45°. The same applied to the other graphs (Cutoff 20, Cutoff 50, Cutoff 100, Cutoff 160). That is, the average angle A2 meant that the network structure 51 of the element 5 having a plurality of constituent elements 51a approximated to nanorods was randomly oriented.

In FIG. 14, an image obtained by capturing the data element D created by the creating device 2 was used. In this case, this meant that, when a center-to-center distance CD (CNT-CNT distance) between paired nanorods increased, the network structure D1 of the data element D having a plurality of constituent elements approximated to nanorods was randomly oriented.

A predetermined average angle was set as the relationship between this center-to-center distance CD and the average angle. For example, in the present example, a predetermined average angle A1) (22.5°) was set. CNT-CNT distances at points (w, x, y, z) where the average angle A1 and the graphs (Cutoff 0, Cutoff 20, Cutoff 50, Cutoff 100, Cutoff 160) intersect were C20, C50, C100, and C160.

C20, C50, C100, and C160 were C20˜CNT-CNT distance 20, C50˜CNT-CNT distance 50, C100˜CNT-CNT distance 100, C160˜CNT-CNT distance 160. Thus, it was confirmed that these values could be correlated with the correlation distance R that was set in the network structure D1 of the data element D created by the creating device 2.

From the above, it could be confirmed that the network structure of the element can have the value of a CNT-CNT distance, which was determined when the average angle was set to a certain predetermined value, as a correlation distance R based on the relationship between the center-to-center distance CD and the average angle.

The table in FIG. 13 and the graphs in FIG. 14 are examples, and the layouts and the like are not limited thereto.

Although the example embodiments of the disclosure have been described above, the example embodiments are shown as examples and are not intended to limit the scope of the disclosure. These example embodiments can be implemented in various other forms, and various omissions, substitutions, and changes can be made without departing from the gist of the disclosure. These example embodiments and their modifications are included within the scope and gist of the disclosure, as well as within the scope of the disclosure and its equivalents. Each example embodiment can be combined with other embodiments as appropriate.

Some or all of the above-described example embodiments may be described as in the following supplementary notes, but are not limited to the following.

### Supplementary Note 1

An extraction device including:
a memory configured to store instructions; and
a processor configured to execute the instructions to:
extract a plurality of nanorods based on an image of a network structure including a plurality of constituent elements approximated to the plurality of nanorods;
acquire an inter-nanorod distance and an angle between each pair of the plurality of nanorods; and
determine a correlation distance based on a relationship between the inter-nanorod distance and the angle.

### Supplementary Note 2

The extraction device according to supplementary note 1, wherein the processor is configured to execute the instructions to totalize, as a representative angle, a representative value of the angle for each inter-nanorod distance, and determine, as the correlation distance, the inter-nanorod distance in a case where the representative angle is a predetermined value based on a relationship between the inter-nanorod distance and the representative angle.

### Supplementary Note 3

The extraction device according to supplementary note 1 or 2, wherein the constituent elements are nanocarbons.

### Supplementary Note 4

The extraction device according to any one of supplementary notes 1 to 3, wherein the constituent elements are carbon nanotubes.

### Supplementary Note 5

An image analysis device comprising:
the extraction device according to any one of supplementary notes 1 to 4; and
a microscope configured to capture the image.

### Supplementary Note 6

A creating device including:
a first memory configured to store first instructions; and
a first processor configured to execute the first instructions to:
determine a plurality of centers;
set a correlation distance for each center; and
set a plurality of nanorods based on the correlation distance and a center-to-center distance which is a distance between each pair of the plurality of centers.

### Supplementary Note 7

The creating device according to supplementary note 6, wherein the correlation distance changes orientation of the plurality of nanorods.

### Supplementary Note 8

The creating device according to supplementary notes 6 or 7,
wherein the plurality of centers includes a first center and a second center, and
wherein the first processor is configured to execute the first instructions to set the a first nanorod to the first center along an orientation of a second nanorod which is set for the second center when the second center is present within the correlation distance for the first center.

### Supplementary Note 9

An evaluation system including:
a microscope;
an extraction device; and
the creating device according to any one of supplementary notes 6 to 8,
wherein the microscope is configured to capture an image of a network structure including a plurality of constituent elements approximated to a plurality of nanorods, and
wherein the extraction device includes:
a second memory configured to store second instructions; and
a second processor configured to execute the second instructions to:
extract the plurality of nanorods based on the image,
acquire an inter-nanorod distance and an angle between each pair of the plurality of nanorods, and
determine a correlation distance based on a relationship between the inter-nanorod distance and the angle.

### Supplementary Note 10

A correlation distance extraction method including:
extracting a plurality of nanorods based on an image of a network structure including a plurality of constituent elements approximated to the plurality of nanorods;
acquiring an inter-nanorod distance and an angle between each pair of the plurality of nanorods; and
determining a correlation distance based on a relationship between the inter-nanorod distance and the angle.

### Supplementary Note 11

The correlation distance extraction method according to supplementary note 10, wherein the determining includes totalizing, as a representative angle, a representative value of the angle for each inter-nanorod distance, and determining, as the correlation distance, the inter-nanorod distance in a case where the representative angle is a predetermined value based on a relationship between the inter-nanorod distance and the representative angle.

### Supplementary Note 12

The correlation distance extraction method according to supplementary note 10 or 11, wherein the constituent elements are nanocarbons.

### Supplementary Note 13

The correlation distance extraction method according to any one of supplementary notes 10 to 12, wherein the constituent elements are carbon nanotubes.

### Supplementary Note 14

A non-transitory computer-readable recording medium that records a program causing a computer to execute steps including:
extracting a plurality of nanorods based on an image of a network structure including a plurality of constituent elements approximated to the plurality of nanorods;
acquiring an inter-nanorod distance and an angle between each pair of the plurality of nanorods; and
determining a correlation distance based on a relationship between the inter-nanorod distance and the angle.

### Supplementary Note 15

A data creation method comprising:
determining a plurality of centers;
setting a correlation distance for each center; and
setting a plurality of nanorods based on the correlation distance and a center-to-center distance which is a distance between each pair of the plurality of centers.

### Supplementary Note 16

A non-transitory computer-readable recording medium that records a program causing a computer to execute steps including:
determining a plurality of centers;
setting a correlation distance for each center; and
setting a plurality of nanorods based on the correlation distance and a center-to-center distance which is a distance between each pair of the plurality of centers.

According to the extraction device, the image analysis device, the creating device, the evaluation system, the correlation distance extraction method, and the recording medium, it is easy to lower the electrical resistance of a network structure.

What is claimed is:

1. An extraction device comprising:
a memory configured to store instructions; and
a processor configured to execute the instructions to:
extract a plurality of nanorods based on an image of a network structure including a plurality of constituent elements approximated to the plurality of nanorods;
acquire an inter-nanorod distance and an angle between each pair of the plurality of nanorods; and
determine a correlation distance based on a relationship between the inter-nanorod distance and the angle.

2. The extraction device according to claim 1, wherein the processor is configured to execute the instructions to totalize, as a representative angle, a representative value of the angle for each inter-nanorod distance, and determine, as the correlation distance, the inter-nanorod distance in a case where the representative angle is a predetermined value based on a relationship between the inter-nanorod distance and the representative angle.

3. The extraction device according to claim 1, wherein the constituent elements are nanocarbons.

4. The extraction device according to claim 1, wherein the constituent elements are carbon nanotubes.

5. The extraction device according to claim 2, wherein the constituent elements are nanocarbons.

6. The extraction device according to claim 2, wherein the constituent elements are carbon nanotubes.

7. An image analysis device comprising:
the extraction device according to claim 1; and
a microscope configured to capture the image.

8. The image analysis device according to claim 7, wherein the processor is configured to execute the instructions to totalize, as a representative angle, a representative value of the angle for each inter-nanorod distance, and determine, as the correlation distance, the inter-nanorod distance in a case where the representative angle is a predetermined value based on a relationship between the inter-nanorod distance and the representative angle.

9. The image analysis device according to claim 7, wherein the constituent elements are nanocarbons.

10. The image analysis device according to claim 7, wherein the constituent elements are carbon nanotubes.

11. A creating device comprising:
a first memory configured to store first instructions; and
a first processor configured to execute the first instructions to:
determine a plurality of centers;
set a correlation distance for each center; and
set a plurality of nanorods based on the correlation distance and a center-to-center distance which is a distance between each pair of the plurality of centers.

12. The creating device according to claim 11, wherein the correlation distance changes orientation of the plurality of nanorods.

13. The creating device according to claim 11,
wherein the plurality of centers includes a first center and a second center, and
wherein the first processor is configured to execute the first instructions to set the a first nanorod to the first center along an orientation of a second nanorod which is set for the second center when the second center is present within the correlation distance for the first center.

14. The creating device according to claim 12,
wherein the plurality of centers includes a first center and a second center, and
wherein the first processor is configured to execute the first instructions to set the a first nanorod to the first center along an orientation of a second nanorod which is set for the second center when the second center is present within the correlation distance for the first center.

15. An evaluation system comprising:
a microscope;
an extraction device; and
the creating device according to claim 11,
wherein the microscope is configured to capture an image of a network structure including a plurality of constituent elements approximated to a plurality of nanorods, and
wherein the extraction device comprises:
a second memory configured to store second instructions; and
a second processor configured to execute the second instructions to:
extract the plurality of nanorods based on the image,
acquire an inter-nanorod distance and an angle between each pair of the plurality of nanorods, and
determine a correlation distance based on a relationship between the inter-nanorod distance and the angle.

16. A correlation distance extraction method comprising:
extracting a plurality of nanorods based on an image of a network structure including a plurality of constituent elements approximated to the plurality of nanorods;
acquiring an inter-nanorod distance and an angle between each pair of the plurality of nanorods; and
determining a correlation distance based on a relationship between the inter-nanorod distance and the angle.

17. The correlation distance extraction method according to claim 16, wherein the determining includes totalizing, as a representative angle, a representative value of the angle for each inter-nanorod distance, and determining, as the correlation distance, the inter-nanorod distance in a case where the representative angle is a predetermined value based on a relationship between the inter-nanorod distance and the representative angle.

18. The correlation distance extraction method according to claim 16, wherein the constituent elements are nanocarbons.

19. The correlation distance extraction method according to claim 16, wherein the constituent elements are carbon nanotubes.

20. The correlation distance extraction method according to claim 17, wherein the constituent elements are nanocarbons.
